(19) United States
(12) Patent Application Publication
(10) Pub. No.: US 2005/0204079 A1
(43) Pub. Date: Sep. 15, 2005

(54) Data rate adjustment device and system thereof

(75) Inventor: Chi-Peng Tai, Taichung (TW)

Correspondence Address: RATNERPRESTIA, P O BOX 980, VALLEY FORGE, PA, 19482-0980, US

(73) Assignee: BenQ Corporation

(21) Appl. No.: 11/075,435

(22) Filed: Mar. 8, 2005

(30) Foreign Application Priority Data
Mar. 9, 2004 (TW) 093106148

(51) Int. Cl. G06F 3/00

(52) U.S. Cl. 710/52

(57) ABSTRACT

A device and a wireless communication system for converting input signals of different data rates to output signals of the same date rate are provided. The device and the wireless communication system include a plurality of task elements with priority and according to the priority, the present invention can provide process signals in real-time to reduce time of signal processing.

This Application claims the right of priority based on Taiwan Patent Application No. 093106148 filed on Mar. 9, 2004.

### FIELD OF THE INVENTION

The present invention relates to a data rate adjustment device employed in a wireless communication system for converting data rates and processing data in real-time.

### BACKGROUND OF THE INVENTION

As the wireless communication technique progresses, the products for simultaneously transmitting different kinds of signals also emerge. For example, mobile phones nowadays can transmit video, audio and data signals simultaneously. However, different kinds of signals usually have different data rates. For video/audio signals, video signals and audio signals are transmitted in different rates along different paths, and these signals need to synchronize when they are received and needed to output simultaneously. Therefore, before transmitting the signal, the wireless communication system needs a device to integrate the signals of different data rates into a same outputting rate, ensuring the signals to be transmitted synchronically.

A Time Division Multiplex (TDM) system appropriately allots time segments to each process module or task element of the system in a predetermined way (proportionately or non-proportionately). However, the data amount and the rates of each process module or task element are not identical, making some of the process modules or task elements either idle or jammed at an input end, resulting in degradation of the system performance.

United States Publication Number U.S. 2003/0123406 and U.S. 2003/0128674 have disclosed methods and apparatus for unifying data rates of signals, which is convenient during transmission, but wastes time and does not meet a high-speed operation demand. Therefore, a device to integrate signals of different data rates to the same date rate is desired.

### SUMMARY

The present invention provides a data rate adjustment device employed to a wireless communication system for processing a first input signal to a first output signal and a second input signal to a second output signal in real-time. The first input signal and the second input signal may be transmitted in different data rates to the device of the present invention, and then these signals are converted and then transmitted in the same outputting rate. Therefore, the device of the present invention can process the signals in real-time and reduce the process time.

The data rate adjustment device of the present invention includes a first task element, a second task element, a third task element and a fourth task element. The first task element is used to divide the first input signal and the second input signal to form a first data set and a second data set respectively. The second task element is used to receive the first data set. The third task element is used to receive the second data set. The fourth task element is used to transmit the first data set to form the first output signal and transmit the second data set to form the second output signal.

The first task element, the second task element, the third task element, and the fourth task element are configured to have the first priority, the second priority, the third priority and the fourth priority respectively. The device of the present invention determines execution sequences of the first task element, the second task element, the third task element and the fourth task element according to the first priority, the second priority, the third priority and the fourth priority, so that the device of the present invention can effectively process the data in real-time.

The present invention further provides a wireless communication system for processing a plurality of downlink signals in real-time. The wireless communication system includes a first device, a second device and a third device. The first device is used to generate the first input signal and the second input signal mentioned above. The second device includes the first task element, the second task element, the third task element, and the fourth task element mentioned above. The third device receives the first output signal and the second output signal by wireless communication. This wireless communication system can convert signals of different data rates to the same outputting rate and reduce the time of data processing.

### BRIEF DESCRIPTION OF THE DRAWINGS

FIG. 1 is a block diagram of the data rate adjustment device of the present invention.

FIG. 2 is a schematic diagram of the wireless communication system of the present invention.

### DETAILED DESCRIPTION

The data rate adjustment device of the present invention converts signals of different data rates to output signals of the same outputting rate in real-time. “Real-time” mentioned herein refers to the TDM, in which a given time period is divided into several sequences and the sequences are assigned to task elements in the device in a predetermined way (proportionately or non-proportionately) appropriately.

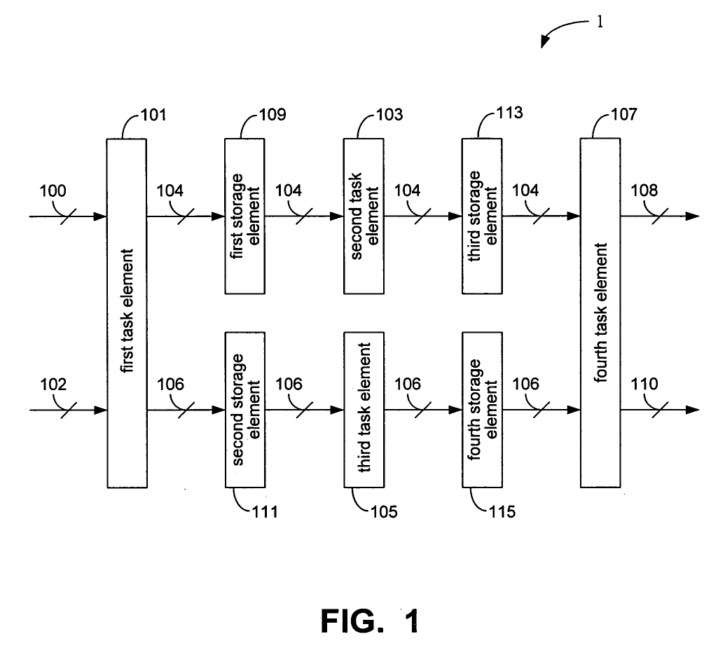

An embodiment of the data rate adjustment device 1, shown in FIG. 1, includes a first task element 101, a second task element 103, a third task element 105, and a fourth task element 107.

The first task element 101 is used to receive a first input signal 100 and a second input signal 102, which may be transmitted thereinto in different data rates. The first task element 101 divides the first input signal 100 and the second input signal 102 based on the specific length of the data to form a first data set 104 and a second data set 106 respectively. Therefore, the first data set 104 and the second data set 106 are comprised of a plurality of data segments of equal length respectively. It should be noted that the specific length of the data depends on the hardware designed of the data rate adjustment device 1 and requirements of systems. The first task element 101 is configured to have a first priority.

The second task element 103 and the third task element 105 are used to receive the first data set 104 and the second data set 106 from the first task element 101 respectively. The second task element 103 is configured to have a second priority, and the third task element 105 is configured to have a third priority.

The fourth task element 107 receives the first data set 104 and the second data set 106, and then within a given time, transmits the first data set 104 to form a first output signal 108, and transmits the second data set 106 to form a second output signal 110 simultaneously. The fourth task element 107 is configured to have a fourth priority. It should be noted that the given time depends on acceptable or expectable data rate of the data rate adjustment device 1.

After processing by the first task element 101, the length of each data segment of the first data set 104 is the same as that of the second data set 106. The first output signal 108 and the second output signal 110 therefore have respectively the same rate.

The data rate adjustment device 1 determines execution sequences of the first task element 101, the second task element 103, the third task element 105 and the fourth task element 107 according to the first priority, the second priority, the third priority and the fourth priority. In this embodiment, the first input signal 100 is an audio signal, and the second input signal 102 is a video signal. Typically, data rate of the video signal (e.g. 41.2 Kbps) is greater than that of the audio signal (e.g. 12.8 Kbps), therefore the fourth priority is designed to be dominant to the third priority, the third priority is designed to be dominant to the second priority, and the second priority is designed to be dominant to the first priority. That is, during process sequences, the fourth task element 107 is dominant to other task elements, or the execution time of the fourth task element 107 is the longest. The first task element 101 is processed last, and its execution time is the shortest. This arrangement ensures that the execution of the video signals in the data rate adjustment device 1 is dominant to that of the audio signals, and that the video signals can be processed in the data rate adjustment device 1 longer. This ensures that the video signals and the audio signals are simultaneously transmitted.

The provision of the second task element 103 and the third task element 105 allows more process stages of the data rate adjustment device 1. The use of the corresponding priorities allows speeding up of the data processes of the first data set 104 and the second data set 106 without waiting for next process time for the fourth task element 107.

As shown in FIG. 1, the data rate adjustment device 1 further includes a first storage element 109, a second storage element 111, a third storage element 113 and a fourth storage element 115. The first storage element 109 receives and storages the first data set 104 from the first task element 101, and then transmits the first data set 104 according to the signal from the second task element 103. The second storage element 111 receives and storages the second data set 106 from first task element 101, and then transmits the second data set 106 according to the signal from the third task element 105. The third storage element 113 receives and storages the first data set 104 from the second task element 103, and then transmits the first data set 104 according to the signal from the fourth task element 107. The fourth task element 107 receives and storages the second data set 106 from the third task element 105, and then transmits the second data set 106 according to the signal from the fourth task element 107. The priority sequences of the first priority, the second priority, the third priority and the fourth priority can be dynamically adjusted based on the data amount stored in the first storage element 109, the second storage element 111, the third storage element 113 and the fourth storage element 115. For example, as the data amount stored in the first storage element 109 and the second storage element 111 are greater than a predetermined value, the dominances of the first priority, the second priority and the third priority may be selectively changed. As the data amount stored in the third storage element 113 and the fourth storage element 115 are greater than a predetermined value, the dominances of the second priority, the third priority and the fourth priority may be selectively changed.

The data rate adjustment device 1 is employed in a wireless communication system for processing the downlink signals. One embodiment of the first task element 101, the second task element 103, the third task element 105 and the fourth task element 107 are task control blocks respectively. The first storage element 109 and the second storage element 111 are buffers respectively. And the third storage element 113 and the fourth storage element 115 are message queues respectively.

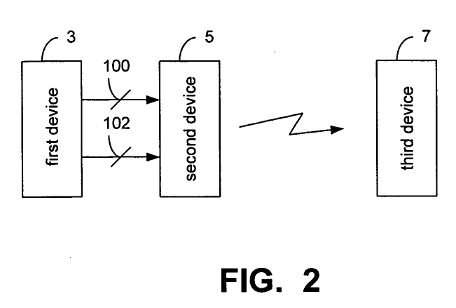

According to the data rate adjustment device 1, a wireless communication system for processing a plurality of the downlink signals in real-time, shown in FIG. 2, is provided. The wireless communication system includes a first device 3, a second device 5 and a third device 7. The first device 3 is used to generate the first input signal 100 and the second input signal 102 mentioned above, and then transmits the first input signal 100 and the second input signal 102 to the second device 5 using wired communication, such as Internet. The second device 5 includes the device 1 shown in FIG. 1. The third device 7 is the client of the wireless communication system (e.g. mobile phone) receiving the first output signal and the second output signal from the second device 5 using wireless communication.

Since the second device 5 includes the data rate adjustment device 1 shown in FIG. 1, the wireless communication system of the present invention can be used to convert signals with different data rates to the same outputting rate, and then transmit these signals. As a result, the wireless communication system provided reduces process time.

By means of the detailed descriptions of what is presently considered to be the most practical and preferred embodiments of the subject invention, it is the expectation that the features and the gist thereof are plainly revealed. Nevertheless, these above-mentioned illustrations are not intended to be construed in a limiting sense. Instead, it should be well understood that any analogous variation and equivalent arrangement is supposed to be covered within the spirit and scope to be protected and that the interpretation of the scope of the subject invention would therefore as much as broadly apply.

1. A device for processing a first input signal to a first output signal and a second input signal to a second output signal in real-time, the device comprising:
a first task element for dividing the first input signal and the second input signal into a first data set and a second data set respectively, the first task element having a first priority, the first data set including multiple data segments of equal length, the second data set including multiple data segments of equal length;
a second task element for receiving the first data set, the second task element having a second priority;
a third task element for receiving the second data set, the third task element having a third priority; and
a fourth task element for receiving the first data set from the second task element and transmitting the first data set to form the first output signal and receiving the second data set from the third task element and transmitting the second data set to form the second output signal, the fourth task element having a fourth priority;
wherein the device determines execution sequences of the first task element, the second task element, the third task element and the fourth task element according to the first priority, the second priority, the third priority and the fourth priority, making the first output signal and the second output signal to have the same outputting rate.

2. The device of claim 1, wherein the first input signal and the second input signal are transmitted to the device in different data rates, and the first output signal and the second output signal are transmitted from the device in the same outputting rate.

3. The device of claim 1, wherein the first input signal is an audio signal, and the second input signal is a video signal.

4. The device of claim 3, wherein the fourth priority is dominant to the third priority, the third priority is dominant to the second priority, and the second priority is dominant to the first priority.

5. The device of claim 1 further comprising:
a first storage element for receiving the first data set from the first task element, and transmitting the first data set to the second task element;
a second storage element for receiving the second data set from the first task element, and transmitting the second data set to the third task element;
a third storage element for receiving the first data set from the second task element, and transmitting the first data set to the fourth task element; and
a fourth storage element for receiving the second data set from the third task element, and transmitting the second data set to the fourth task element.

6. The device of claim 5, wherein the device is employed in a wireless communication system, the first task element, the second task element, the third task element and the fourth task element are task control blocks respectively, the first storage element and the second storage element are buffers respectively, and the third storage element and the fourth storage element are message queues respectively.

7. The device of claim 5, wherein as a data amount stored in at least one of the first storage element and the second storage element is greater than a predetermined value, priority of the first priority, the second priority and the third priority is selectively changed.

8. The device of claim 5, wherein as a data amount stored in at least one of the third storage element and the fourth storage element is greater than a predetermined value, dominances of the second priority, the third priority and the fourth priority is selectively changed.

9. A device for processing a plurality of downlink signals in a wireless communication system in real-time, the plurality of downlink signals comprising a first input signal and a second input signal, the first input signal and the second input signal are transmitted to the device in different data rates, the device comprising:
a first task element for dividing the first input signal and the second input signal into a first data set and a second data set respectively, the first task element having a first priority, the first data set including multiple data segments of equal length, the second data set including multiple data segments of equal length;
a first storage element for receiving the first data set from the first task element;
a second storage element for receiving the second data set from the first task element;
a second task element for receiving and transmitting selectively the first data set from the first storage element, the second task element having a second priority;
a third task element for receiving and transmitting selectively the second data set from the second storage element, the third task element having a third priority;
a third storage element for receiving the first data set from the second task element;
a fourth storage element for receiving the second data set from the third task element; and
a fourth task element for receiving the first data set from the third storage element and the second data set from the fourth storage element, and transmitting the first data set to form a first output signal and transmitting the second data set to form a second output signal at the same time, making the first output signal and the second output signal to have the same outputting rate, the fourth task element having a fourth priority;
wherein the device determines execution sequences of the first task element, the second task element, the third task element and the fourth task element according to the first priority, the second priority, the third priority and the fourth priority.

10. The device of claim 9, wherein the first task element, the second task element, the third task element and the fourth task element are task control blocks respectively, the first storage element and the second storage element are buffers respectively, and the third storage element and the fourth storage element are message queues respectively.

11. The device of claim 9, wherein the first input signal is an audio signal, and the second input signal is a video signal.

12. The device of claim 11, wherein the fourth priority is dominant to the third priority, the third priority is dominant to the second priority, and the second priority is dominant to the first priority.

13. A wireless communication system for processing a plurality of downlink signals in real-time, comprising:
a first device for generating a first input signal and a second input signal, the first input signal and the second input signal having different data rates;
a second device comprising:
a first task element for dividing the first input signal and the second input signal into a first data set and a second data set respectively, the first task element having a first priority, the first data set including multiple data segments of equal length, the second data set including multiple data segments of equal length;
a first storage element for receiving the first data set from the first task element;
a second storage element for receiving the second data set from the first task element;
a second task element for receiving and transmitting selectively the first data set, the second task element having a second priority;
a third task element for receiving and transmitting selectively the second data set from the second storage element, the third task element having a third priority;
a third storage element for receiving the first data set from the second task element;
a fourth storage element for receiving the second data set from the third task element; and
a fourth task element for receiving the first data set from the third storage element and the second data set from the fourth storage element, and transmitting the first data set to form a first output signal and transmitting the second data set to form a second output signal at the same time, making the first output signal and the second output signal to have the same outputting rate, the fourth task element having a fourth priority; and
a third device receiving the first output signal and the second output signal by wireless communication;
wherein the second device determines execution sequences of the first task element, the second task element, the third task element and the fourth task element according to the first priority, the second priority, the third priority and the fourth priority.

14. The wireless communication system of claim 13, wherein the first task element, the second task element, the third task element and the fourth task element are task control blocks respectively, the first storage element and the second storage element are buffers respectively, and the third storage element and the fourth storage element are message queues respectively.

15. The wireless communication system of claim 13, wherein the first input signal is an audio signal, and the second input signal is a video signal.

16. The wireless communication system of claim 15, wherein the fourth priority is dominant to the third priority, the third priority is dominant to the second priority, and the second priority is dominant to the first priority.
